(19) United States
(12) Patent Application Publication
(10) Pub. No.: US 2018/0107129 A1
(43) Pub. Date: Apr. 19, 2018

(54) CARRIER CORE MATERIAL AND ELECTROPHOTOGRAPHIC DEVELOPMENT CARRIER USING SAME AND ELECTROPHOTOGRAPHIC DEVELOPER

(71) Applicants: DOWA ELECTRONICS MATERIALS CO., LTD., Tokyo (JP); DOWA IP CREATION CO., LTD., Okayama-shi, Okayama (JP)

(72) Inventors: Yohei ISHIKAWA, Okayama-shi (JP); Shinya SASAKI, Okayama-shi (JP)

(73) Assignees: DOWA ELECTRONICS MATERIALS CO., LTD., Tokyo (JP); DOWA IP CREATION CO., LTD., Okayama-shi, Okayama (JP)

(21) Appl. No.: 15/556,398

(22) PCT Filed: Mar. 3, 2016
(86) PCT No.: PCT/JP2016/056521

§ 371 Date: Sep. 7, 2017

(30) Foreign Application Priority Data
Mar. 10, 2015 (JP) 2015-046574

(51) Int. Cl. G03G 9/107; G03G 9/113; C01G 49/00

(52) U.S. Cl. CPC G03G 9/1075; G03G 9/1132; C01P 2006/40; C01G 49/0072; C01P 2004/61; C01G 49/0036

(57) ABSTRACT

A carrier core material is represented by a composition formula MₓFe₃₋ₓO₄ (where M is Mn and/or Mg, and X is a total of Mn and Mg and is a substitution number of Fe by Mn and Mg, 0<X≤1), in which 5 to 20 number percent of bound particles in which 2 to 5 spherical particles are bound together are contained, and in which the absolute value of a difference between lattice constants before and after milling which are calculated from a peak position of plane indices in a powder X-ray diffraction pattern is equal to or less than 0.005. In this way, it is possible to increase the amount of toner supplied to a development region, and even when cracking or chipping occurs in the carrier core material, an image failure such as black spots or white spots is prevented from being generated.

### TECHNICAL FIELD

The present invention relates to a carrier core material and an electrophotographic development carrier using such a carrier core material and an electrophotographic developer.

### BACKGROUND ART

For example, in an image forming apparatus using an electrophotographic system, such as a facsimile, a printer or a copying machine, a toner is adhered to an electrostatic latent image formed on the surface of a photosensitive member to visualize it, the visualized image is transferred to a sheet or the like and thereafter it is fixed by being heated and pressurized. In terms of achieving high image quality and colorization, as a developer, a so-called two-component developer containing a carrier and a toner is widely used.

In a development system using a two-component developer, a carrier and a toner are agitated and mixed within a development device, and the toner is charged by friction so as to have a predetermined amount. Then, the developer is supplied to a rotating development roller, a magnetic brush is formed on the development roller and the toner is electrically moved to the photosensitive member through the magnetic brush to visualize the electrostatic latent image on the photosensitive member. The carrier after the movement of the toner is left on the development roller, and is mixed again with the toner within the development device. Hence, as the properties of the carrier, a magnetic property for forming the magnetic brush and a charging property for providing a desired charge to the toner are required. As such a carrier, a so-called coating carrier which is obtained by coating, with a resin, the surface of a carrier core material formed of magnetite, various types of ferrites or the like has so far been often used. The carrier core material which has so far been used for the coating carrier is formed in the shape of a perfect sphere.

In recent years, there has been a tendency that in order to cope with the market demand for increasing the speed of image formation in an image forming apparatus, the rotation speed of a development roller is increased such that the amount of developer supplied to a development region per unit time is increased.

However, in the coating carrier using the carrier core material in the shape of a perfect sphere, a failure is encountered in which the supply of the toner to the development region is insufficient and in which thus an image density is lowered. For example, a failure called development memory is encountered in which the image density is lowered by the influence of an image in the preceding revolution of the development roller.

Hence, a technology is proposed in which the surface of the carrier core material is formed in a concave-convex shape or different shapes of the carrier core material are formed, and in which thus frictional resistance to the surface of a photosensitive member and the frictional resistance of carriers are increased such that the amount of toner supplied to the development region is increased (for example, patent documents 1 and 2).

### RELATED ART DOCUMENT

### Patent Document

Patent Document 1: Japanese Unexamined Patent Application Publication No. 2013-25204

Patent Document 2: Japanese Unexamined Patent Application Publication No. 2007-148452

### DISCLOSURE OF THE INVENTION

### Problems to be Solved by the Invention

However, the concave-convex shape is only formed in the surface of the carrier core material, thus a coat resin is formed as a thick film in the concave portion when the surface of the carrier core material is coated with the resin and hence the concave and convex portions in the surface of the coating carrier are insufficient, with the result that the holding property of the toner is not sufficient. Although as carriers having different shapes, carriers which have an unequal polygonal shape or a massive shape are proposed, since the carriers have the extremely different shapes which deviate from a spherical shape, cracking or chipping easily occurs in the carrier core material. The chips of the carrier core material produced by the cracking or chipping often have electrical resistance lower than the original electrical resistance of the carrier core material, and are adhered to the surface of the photosensitive member so as to disadvantageously form black spots or white spots in an image.

Hence, an object of the present invention is to provide a carrier core material which can increase the amount of toner supplied to a development region and in which even when cracking or chipping occurs in the carrier core material, an image failure such as black spots or white spots is prevented from being generated.

Another object of the present invention is to provide an electrophotographic development carrier and an electrophotographic developer which can stably form satisfactory quality images even in long-term use.

### Means for Solving the Problem

According to the present invention, there is provided a carrier core material that is represented by a composition formula MₓFe₃₋ₓO₄ (where M is Mn and/or Mg, and X is a total of Mn and Mg and is a substitution number of Fe by Mn and Mg, 0<X≤1), where 5 to 20 number percent of bound particles in which 2 to 5 spherical particles are bound together are contained, and the absolute value of a difference between lattice constants before and after milling which are calculated from a peak position of plane indices (311) in a powder X-ray diffraction pattern is equal to or less than 0.005. The analysis depth of the powder X-ray diffraction pattern is about 1 μm. A method of calculating the lattice constant will be described in examples to be discussed later. In the present specification, unless otherwise particularly specified, “to” is used to mean that values mentioned before and after the “to” are included as the lower limit value and the upper limit value.

In the carrier core material according to the present invention, a volume average particle diameter (hereinafter also simply referred to as an “average particle diameter”) is preferably equal to or more than 25 μm but less than 50 μm.

Moreover, according to the present invention, there is provided an electrophotographic development carrier, where the surface of the carrier core material described above is coated with a resin.

Furthermore, according to the present invention, there is provided an electrophotographic developer including: the electrophotographic development carrier described above; and a toner.

### Advantages of the Invention

According to the carrier core material of the present invention, it is possible to increase the amount of toner supplied to a development region and reduce the occurrence of development memory. Even when cracking or chipping occurs in the carrier core material, the adherence of carriers to the surface of a photosensitive member is reduced, and thus an image failure such as black spots or white spots is reduced.

With a developer containing the carrier core material according to the present invention, it is possible to stably form satisfactory quality images even in long-term use.

### BRIEF DESCRIPTION OF DRAWINGS

FIG. 1 A SEM photograph of a carrier core material in example 1;

FIG. 2 A SEM photograph of a carrier core material in example 2;

FIG. 3 A SEM photograph of a carrier core material in example 3;

FIG. 4 A SEM photograph of a carrier core material in example 4;

FIG. 5 A SEM photograph of a carrier core material in example 5;

FIG. 6 A SEM photograph of a carrier core material in comparative example 1;

FIG. 7 A SEM photograph of a carrier core material in comparative example 2; and

FIG. 8 A schematic diagram showing an example of a development device using a carrier according to the present invention.

### DESCRIPTION OF EMBODIMENTS

The present inventors et al. have first conducted a thorough study of increasing the amount of toner supplied to a development region, and consequently have found that a predetermined number of bound particles in which a few ferrite spherical particles are bound together are preferably contained as a content in a carrier core material. When a predetermined number of bound particles in which 2 to 5 spherical particles are bound together and which have different shapes that significantly deviate from a spherical shape are contained as a content in the carrier core material, spaces in which a toner is captured can be produced between the normal particles other than the bound particles and the bound particles. Then, the toner captured in the spaces between the normal particles and the bound particles is transported by the rotation of a development roller to a development region, and the toner captured in the spaces appears on the surface of a magnetic brush and contributes to development. Moreover, unlike the conventional carrier of an unequal polygonal shape or a massive shape, the bound particles used in the present invention do not have corner portions because the bound particles are particles obtained by binding together spherical particles. Hence, even when the surface of a photosensitive member is rubbed with the magnetic brush, the surface of the photosensitive member is prevented from being scratched with the corner portions of the particles.

Specifically, a carrier core material according to the present invention is a carrier core material that is represented by a composition formula MₓFe₃₋ₓO₄ (where M is Mn and/or Mg, and X is a total of Mn and Mg and is a substitution number of Fe by Mn and Mg, 0<X≤1), 5 to 20 number percent of bound particles in which 2 to 5 spherical particles are bound together are contained. The carrier core material is a powder which is formed with ferrite particles, and here the normal particles other than the bound particles of the present invention are preferably spherical.

Although the individual particle diameters of the spherical particles forming the bound particle are not particularly limited, the bound particle is preferably a particle in which a mother particle whose particle diameter is the largest and 1 to 4 child particles whose particle diameters are smaller than that of the mother particle are bound together. Furthermore, the bound particle is preferably a particle in which the particle diameter of at least one child particle is larger than a half of the particle diameter of the mother particle. A predetermined proportion of the bound particles described above are contained in the carrier core material, thus the spaces between the normal particles and the bound particles in which the toner can be captured and the spaces between the bound particles are increased in size and hence a larger amount of toner is transported to the development roller, with the result that it is possible to effectively reduce the occurrence of development memory.

Since the bound particle is present in a form in which a bound portion is shared by the mother particle and the child particles, the particle diameters of the mother particle and the child particle were individually calculated by approximating the particle to a spherical shape from a region obtained by removing the bound portion of the bound particle in an image that was obtained by shooting the shape of the carrier core material with a scanning electron microscope (JSM-6510LA made by JEOL Ltd.) at a magnification of 250.

In the bound particle used in the present invention, the compositions of the mother particle and the child particle may be the same as each other or may be different from each other.

For example, the bound particles described above can be obtained by, in a process of manufacturing the carrier core material which will be described later, increasing a holding time at a calcination temperature or adjusting a disintegration operation after the calcination. With this method, it is possible to easily adjust the content of the bound particles in the carrier core material.

Alternatively, the bound particles can be obtained by, in the process of manufacturing the carrier core material, mixing and calcining granulated materials which have different average particle diameters. With this method, it is possible to easily adjust the content of the bound particles in the carrier core material and simultaneously to easily adjust the particle diameters of the mother particle and the child particle to the desired particle diameters.

The content of the bound particles in the carrier core material is 5 to 20 number percent. When the content of the bound particles is less than 5 number percent, the amount of toner supplied to the development region may be insufficient whereas when the content of the bound particles exceeds 20 number percent, the fluidity of the carrier core material is excessively degraded, and thus the circulation and movement of the carrier within the magnetic brush are not sufficiently performed, with the result that when the speed of image formation is increased, it is impossible to obtain a sufficient image density. More preferably, the content of the bound particles falls within a range of 10 to 20 number percent.

Incidentally, the carriers in which the surface of the carrier core material is coated with a resin are agitated and mixed with the toner within a development device, and charge the toner such that the toner has a predetermined amount of charge. By the agitation and the like within the development device, cracking or chipping can occur in the carriers. In particular, since the bound particles in which a plurality of spherical particles are bound together have high agitation resistance, cracking or chipping occurs more easily than normal carriers. In a conventional carrier core material, physical properties differ between the surface and the interior of the particle. Specifically, the interior of the carrier particle is often lower in electrical resistance than the surface thereof. Hence, it is likely that when cracking or chipping occurs in the carriers, the interior of the carrier particles is exposed, the electrical resistance is lowered, the amount of charge is lowered and the carriers are moved and adhered to the photosensitive member. When the carriers are adhered to the photosensitive member, the surface charge of the adherence portions is lowered, and thus they appear as black spots or white spots in an image.

Hence, the present inventors et al. made the physical properties remain the same between the surface and the interior of the carrier core material so that even when cracking or chipping occurred in the carrier core material, the carriers were prevented from being adhered to the photosensitive member. Then, the present inventors et al. used a specific lattice constant as one index for indicating the physical properties of the carrier core material, milled the carrier core material and determined, by subtraction, the absolute value of a difference between the lattice constants before and after the milling. The difference between the lattice constants was made equal to or less than a predetermined value, and thus the homogeneity of the surface and the interior of the carrier core material was specified.

The volume average particle diameter of the carrier core material of the present invention preferably falls within a range which is equal to or more than 25 μm but less than 50 μm, and more preferably falls within a range which is equal to or more than 30 μm but equal to or less than 40 μm.

Although a method of manufacturing the carrier core material of the present invention is not particularly limited, a manufacturing method which will be described below is preferable.

First, a Fe component raw material, a Mn component raw material, a Mg component raw material and as necessary, an additive such as a Sr component are weighed. As the Fe component raw material, Fe₂O₃ or the like is preferably used. As a M component raw material, for Mn, MnCO₃, Mn₃O₄ or the like can be used, and for Mg, MgO, Mg(OH)₂ or MgCO₃ can be preferably used. As the Sr component raw material, SrCO₃, Sr(NO₃)₂ or the like is preferably used.

Then, the raw materials are put into the dispersion medium so as to produce the slurry. As the dispersion medium used in the present invention, water is preferable. The calcination raw material described above and as necessary a binder, a dispersant and the like may be mixed into the dispersion medium. As the binder, for example, polyvinyl alcohol can be preferably used. As the amount of binder mixed, the concentration of the binder in the slurry is preferably set to about 0.5 to 2 mass %. As the dispersant, for example, polycarboxylic acid ammonium or the like can be preferably used. As the amount of dispersant mixed, the concentration of the dispersant in the slurry is preferably set to about 0.5 to 2 mass %. In addition, a lubricant, a sintering accelerator and the like may be mixed. The solid content concentration of the slurry preferably falls within a range of 50 to 90 mass %. The solid content concentration of the slurry more preferably falls within a range of 60 to 80 mass %. When the solid content concentration of the slurry is equal to or more than 60 mass %, a small number of pores within the particles are produced in the granulated material, and thus it is possible to prevent the insufficient of sintering at the time of the calcination.

After the raw materials weighed are mixed and calcined, they may be put into the dispersion medium so as to produce the slurry. The temperature of the calcination preferably falls within a range of 750 to 900° C. When the temperature of the calcination is equal to or more than 750° C., the partial change of the raw materials into a ferrite caused by the calcination proceeds, only a small amount of gas is generated at the time of the calcination, a reaction between the solids sufficiently proceeds and hence the temperature is preferably equal to or more than 750° C. On the other hand, when the temperature of the calcination is equal to or less than 900° C., the degree of sintering caused by the calcination is low, thus it is possible to sufficiently mill the raw materials in the subsequent slurry milling step and hence the temperature is preferably equal to or less than 900° C. As an atmosphere at the time of the calcination, the atmosphere is preferable.

Then, the slurry produced as described above is wet-milled. For example, a ball mill or a vibration mill is used to perform wet-milling for a predetermined time. The average particle diameter of the milled raw materials is preferably equal to or less than 5 μm and is more preferably equal to or less than 1 μm. Within the vibration mill or the ball mill, a medium having a predetermined particle diameter is preferably present. Examples of the material of the medium include an iron-based chromium steel and an oxide-based zirconia, titania and alumina. As the form of the milling step, either of a continuous type and a batch type may be used. The particle diameter of the milled material is adjusted such as by a milling time, a rotation speed, the material and the particle diameter of the medium used.

Then, the milled slurry is granulated by being sprayed and dried. Specifically, the slurry is introduced into a spray drying machine such as a spray dryer, is sprayed into the atmosphere and is thereby granulated into a spherical shape. The temperature of the atmosphere at the time of the spray drying preferably falls within a range of 100 to 300° C. In this way, it is possible to obtain a spherical granulated material having a particle diameter of 10 to 200 μm. Then, the obtained granulated material is classified with a vibrating screen, and thus the granulated material is produced so as to have a predetermined particle diameter range.

Here, the granulated material which has a large particle diameter after being screened may be used as the mother particle, and the granulated material which has a small particle diameter may be used as the child particle. By this operation, it is possible to control the particle diameters of the mother particle and the child particle even with the classification.

For example, when the mother particle having a particle diameter of 100 μm and the child particle having a particle diameter of 50 μm are produced, a stainless steel sieve which has a sieve opening of 103 μm is used to first classify the granulated material into the granulated material on the sieve and the granulated material under the sieve. Then, the granulated material on the sieve is used as the raw material for the mother particle. On the other hand, the granulated material under the sieve is further classified with a stainless steel sieve which has a sieve opening of 74 μm, and the granulated material under the sieve is used as the raw material for the child particle.

The granulated raw material for the mother particle and the granulated raw material for the child particle are mixed in a predetermined proportion so as to produce a predetermined proportion of the bound particles. In the particle size distribution of the mixed raw material obtained in this way, a plurality of peaks which are not obtained by a normal operation are seen or the particle size distribution is brought into the state of the distribution of different shapes. Although in the mixed raw material, the child particles and the mother particles are temporarily bound together by the mixing operation, it is not particularly necessary to use a binder for the binding, and in a subsequent sintering step, the mother particles and the child particles are mixed so as to be adjacent to each other.

Then, the granulated material described above is put into a furnace heated to a predetermined temperature, and is calcined by a general method for synthesizing ferrite particles, and thus ferrite particles are generated. The calcination temperature preferably falls within a range of 1100 to 1300° C. When the calcination temperature is equal to or less than 1100° C., it is unlikely that phase transformation occurs and that sintering proceeds. When the calcination temperature exceeds 1300° C., excessive grains may be generated by excessive sintering. The content of the bound particles can also be adjusted by the holding time at the calcination temperature, and in general, as the holding time is prolonged, the content of the bound particles is increased. As the holding time, 6 or more hours are preferable. The rate of temperature increase to the calcination temperature preferably falls within a range of 250 to 500° C./h.

The specific difference between the lattice constants before and after the milling of the carrier core material is set equal to or less than a predetermined value, that is, in order to homogenize the surface and the interior of the carrier core material, it is preferable to adjust the time and the temperature for the calcination, an oxygen concentration at the time of calcination and the like. Here, it is important to calcine the granulated material under a reducing atmosphere in temperature increase and holding steps and to calcine the granulated material under an oxidizing atmosphere in a cooling step. Specifically, at the time of the temperature increase and holding, a reducing atmosphere is used, and thus a ferrite formation reaction is made to proceed into the particles homogeneously. Then, in the cooling step, the ferrite particles are slowly cooled under an atmosphere of an oxygen concentration higher than in the temperature increase and holding steps, and thus oxygen is sufficiently diffused into the particles. The control on the atmosphere in the calcination step as described above is performed, and thus it is possible to obtain the carrier core material in which the surface and the interior are homogenized. The calcination temperature in the heating and holding steps preferably falls within a range of 1100 to 1300° C., and the holding time is preferably 6 or more hours. In terms of homogenizing the surface and the interior of the particles, the slow cooling rate in the cooling step is preferably 200° C./h or less. The oxygen concentration in the atmosphere in the cooling step is about 1000 to 20000 ppm.

The calcined material obtained as described above is disintegrated. Specifically, for example, a hammer mill or the like is used to disintegrate the calcined material. As the form of the disintegration step, either of a continuous type and a batch type may be used. By the disintegration processing described above, the content of the bound particles can also be adjusted. In other words, as an impact force applied to the calcined material is increased and prolonged, the binding of the bound particles is released, and thus the content of the bound particles is reduced.

After the disintegration processing, as necessary, classification may be performed such that the particle diameters are made to fall within a predetermined range. As a classification method, a conventional known method such as air classification or sieve classification can be used. After primary classification is performed with an air classifier, with a vibration sieve or an ultrasonic sieve, the particle diameters may be made to fall into the predetermined range. Furthermore, after the classification step, non-magnetic particles may be removed with a magnetic beneficiation machine. The particle diameter of the ferrite particle is preferably equal to or more than 25 μm but less than 50 μm.

Thereafter, as necessary, the ferrite particles after the classification are heated in an oxidizing atmosphere, and thus an oxide film is formed on the surface of the particles, with the result that the resistance of the ferrite particles may be increased (resistance increasing processing). As the oxidizing atmosphere, either of the atmosphere and the mixed atmosphere of oxygen and nitrogen may be used. The heating temperature preferably falls within a range which is equal to or more than 200° C. but equal to or less than 800° C., and more preferably falls within a range which is equal to or more than 360° C. but equal to or less than 500° C. The heating time preferably falls within a range which is equal to or more than 0.5 hours but equal to or less than 5 hours. In terms of homogenizing the surface and the interior of the ferrite particles, the heating temperature is preferably low.

The ferrite particles produced as described above are used as the carrier core material of the present invention. Then, in order for the desired chargeability and the like to be obtained, the outer circumference of the carrier core material is coated with a resin, and is used as an electrophotographic development carrier.

As the resin with which the surface of the carrier core material is coated, a conventional known resin can be used. Examples thereof include polyethylene, polypropylene, polyvinyl chloride, poly-4-methylpentene-1, polyvinylidene chloride, ABS (acrylonitrile-butadiene-styrene) resin, polystyrene, (meth) acrylic-based resin, polyvinyl alcohol-based resin, thermoplastic elastomers such as polyvinyl chloride-based, polyurethane-based, polyester-based, polyamide-based and polybutadiene-based thermoplastic elastomers and fluorine silicone-based resins.

In order to coat the surface of the carrier core material with the resin, a solution of the resin or a dispersion solution is preferably applied to the carrier core material. As a solvent for the coating solution, one or two or more types of the followings can be used: aromatic hydrocarbon-based solvents such as toluene and xylene; ketone-based solvents such as acetone, methyl ethyl ketone, methyl isobutyl ketone and cyclohexanone; cyclic ether-based solvents such as tetrahydrofuran and dioxane; alcohol-based solvents such as ethanol, propanol and butanol; cellosolve-based solvents such as ethyl cellosolve and butyl cellosolve; ester-based solvents such as ethyl acetate and butyl acetate; and amide-based solvents such as dimethyl formamide and dimethylacetamide. The concentration of the resin component in the coating solution generally falls within a range of 0.001 to 30 mass %, and particularly preferably falls within a range of 0.001 to 2 mass %.

As a method of coating the carrier core material with the resin, for example, a spray dry method, a fluidized bed method, a spray dry method using a fluidized bed and a dipping method can be used. Among them, the fluidized bed method is particularly preferable because it is possible to efficiently perform coating even with a small amount of resin. For example, in the case of the fluidized bed method, the amount of resin applied can be adjusted by the amount of resin solution sprayed and a spraying time.

With respect to the particle diameter of the carrier, its volume average particle diameter generally falls within a range which is equal to or more than 25 μm but less than 50 μm, and particularly preferably falls within a range which is equal to or more than 30 μm but equal to or less than 40 μm.

The electrophotographic developer according to the present invention is formed by mixing the carrier produced as described above and the toner. The mixing ratio between the carrier and the toner is not particularly limited, and is preferably determined, as necessary, from development conditions of the development device used or the like. In general, the concentration of the toner in the developer preferably falls within a range of 1 to 15 mass %. This is because when the concentration of the toner is less than 1 mass %, an image density is excessively lowered whereas when the concentration of the toner exceeds 15 mass %, the toner is scattered within the development device, and thus a stain within an apparatus may be produced or a failure may occur in which the toner is adhered to a background part of transfer paper or the like. The concentration of the toner more preferably falls within a range of 3 to 10 mass %.

As the toner, a toner can be used which is manufactured by a conventional known method such as a polymerization method, a milling/classification method, a melting granulation method or a spray granulation method. Specifically, a toner can be preferably used in which a coloring agent, a mold release agent, a charge control agent and the like are contained in a binder resin whose main component is a thermoplastic resin.

With respect to the particle diameter of the toner, in general, its volume average particle diameter by a coulter counter preferably falls within a range which is equal to or more than 5 μm but equal to or less than 15 μm, and more preferably falls within a range which is equal to or more than 7 μm but equal to or less than 12 μm.

A modifier may be added to the surface of the toner as necessary. Examples of the modifier include silica, alumina, zinc oxide, titanium oxide, magnesium oxide and polymethyl methacrylate. One or two or more types thereof can be combined and used.

The mixing of the carrier and the toner can be performed with a conventional known mixing device. For example, a Henschel mixer, a V-type mixer, a tumbler mixer and a hybridizer can be used.

Although a development method using the developer of the present invention is not particularly limited, a magnetic brush development method is preferably used. FIG. 8 shows a schematic diagram showing an example of a development device which performs magnetic brush development. The development device shown in FIG. 8 includes: a development roller 3 which incorporates a plurality of magnetic poles and which is freely rotatable; a regulation blade 6 which regulates the amount of developer on the development roller 3 transported to a development portion; two screws 1 and 2 which are arranged parallel to a horizontal direction and which respectively agitate and transport the developer in opposite directions; and a partition plate 4 which is formed between the two screws 1 and 2, which makes it possible to move the developer from one screw to the other screw at both end portions of the screws and which prevents the movement of the developer in the portions other than both the end portions.

In the two screws 1 and 2, spiral blades 13 and 23 are formed at the same inclination angles on shaft portions 11 and 21 and are rotated by an unillustrated drive mechanism in the same direction so as to respectively transport the developer in the opposite directions. At both the end portions of the screws 1 and 2, the developer is moved from one screw to the other screw. In this way, the developer formed with the toner and the carrier is constantly circulated and agitated within the device.

On the other hand, the development roller 3 includes a fixed magnet where within a metallic cylindrical member having concave and convex portions of a few micrometers in its surface, as a magnetic pole generating means, five magnetic poles of a development magnetic pole N₁, a transport magnetic pole S₁, a separation magnetic pole N₂, a pumping magnetic pole N₃ and a blade magnetic pole S₂ are sequentially arranged. When the development roller 3 is rotated in a direction indicated by an arrow, the developer is pumped up by the magnetic force of the pumping magnetic pole N₃ from the screw 1 to the development roller 3. The developer carried on the surface of the development roller 3 is regulated in layer by the regulation blade 6 and is thereafter transported to the development region.

In the development region, a bias voltage obtained by superimposing an alternating-current voltage on a direct-current voltage is applied from a transfer voltage power supply 8 to the development roller 3. The direct-current voltage component of the bias voltage is set to a potential between the potential of a background portion and the potential of an image portion on the surface of a photosensitive drum 5. The potential of the background portion and the potential of the image portion are set to potentials between the maximum value and the minimum value of the bias voltage. The peak-to-peak voltage of the bias voltage preferably falls within a range of 0.5 to 5 kV, and the frequency preferably falls within a range of 1 to 10 kHz. The waveform of the bias voltage may be any waveform such as a rectangular wave, a sine wave or a triangular wave. In this way, the toner and the carrier are vibrated in the development region, the toner is adhered to an electrostatic latent image on the photosensitive drum 5 and thus the development is performed.

Thereafter, the developer on the development roller 3 is transported by the transport magnetic pole S₁ into the device, is separated by the separation magnetic pole N₂ from the development roller 3, is circulated and transported again by the screws 1 and 2 within the device and is agitated and mixed with the developer which is not subjected to the development. Then, the developer is newly supplied by the pumping magnetic pole N₃ from the screw 1 to the development roller 3.

Although in the embodiment shown in FIG. 8, the number of magnetic poles incorporated in the development roller 3 is five, the number of magnetic poles may naturally be increased to 8, 10 or 12 so that the amount of movement of the developer in the development region is further increased or that the pumping property or the like is further enhanced.

### EXAMPLES

Although examples of the present invention will be more specifically described below, the present invention is not limited at all to these examples.

### Example 1

As raw materials, 7985 g of Fe₂O₃ (average particle diameter: 0.6 μm), 3814 g of Mn₃O₄ (average particle diameter: 0.9 μm) and 113 g of SrCO₃ (average particle diameter: 0.6 μm) were dispersed in 113 g of pure water, and as a dispersant, 70 g of an ammonium polycarboxylate-based dispersant was added, with the result that a mixture was formed. The mixture was subjected to milling processing with a wet ball mill (medium diameter of 2 mm), and thus mixed slurry was obtained.

The mixed slurry was sprayed with a spray drier into hot air of about 130° C., and thus a dried granulated material having a particle diameter of 10 to 75 μm was obtained. Minute particles whose particle diameter was equal to or less than 25 μm were removed from the granulated material with a sieve.

The granulated material was put into an electric furnace, and the temperature thereof was increased to 1170° C. in 4.5 hours. Thereafter, the granulated material was held at 1170° C. for 10 hours, and thus calcination was performed. Then, the granulated material was cooled to room temperature in 10 hours. An oxygen concentration within the electric furnace at the time of the temperature increase and holding was set to 1000 ppm, and then a gas obtained by mixing oxygen and nitrogen was supplied into the furnace such that the oxygen concentration at the time of the cooling was 12000 ppm.

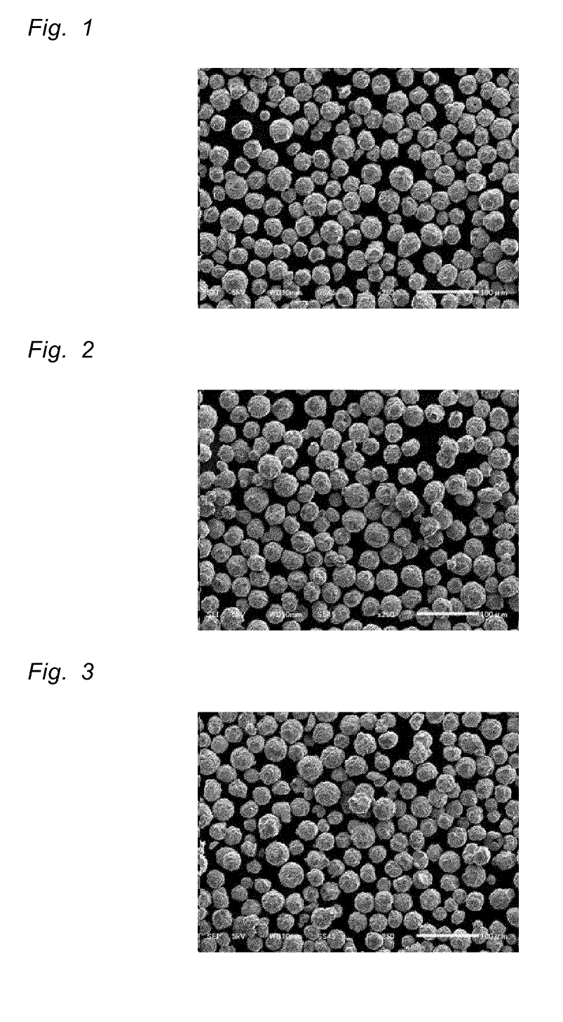

The obtained calcined material was disintegrated twice with a hammer mill (“Hammer Crusher NH-34S” made by Sanshou Industry Co., Ltd., screen opening: 0.3 mm), and thus a carrier core material having an average particle diameter of 33.7 μm was obtained. The composition of the obtained carrier core material, a difference between lattice constants before and after the milling, the particle diameter (diameter) ratio in bound particles, the proportion of the bound particles, the properties of development and the like were measured with methods described later. The results of the measurements are shown in tables 1 and 2. FIG. 1 shows a SEM photograph of the carrier core material in example 1.

### Example 2

A carrier core material having an average particle diameter of 35.1 μm was obtained by the same method as in example 1 except that as raw materials, 7985 g of Fe₂O₃ (average particle diameter: 0.6 μm), 3814 g of Mn₃O₄ (average particle diameter: 0.9 μm) and 111 g of SrCO₃ (average particle diameter: 0.6 μm) were used, that a holding time at the calcination temperature of 1170° C. was set to 8 hours, that the calcined material was disintegrated once with the hammer mill (screen opening: 0.3 mm) and that the calcined material was then disintegrated once with a pulverizer. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 2 shows a SEM photograph of the carrier core material in example 2.

### Example 3

A carrier core material having an average particle diameter of 35.0 μm was obtained by the same method as in example 1 except that as raw materials, 7985 g of Fe₂O₃ (average particle diameter: 0.6 μm), 3814 g of Mn₃O₄ (average particle diameter: 0.9 μm) and 107 g of SrCO₃ (average particle diameter: 0.6 μm) were used, that the holding time at the calcination temperature of 1170° C. was set to 8 hours, that the calcined material was disintegrated once with the hammer mill (screen opening: 0.3 mm) and that the calcined material was then not disintegrated with the pulverizer. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 3 shows a SEM photograph of the carrier core material in example 3.

### Example 4

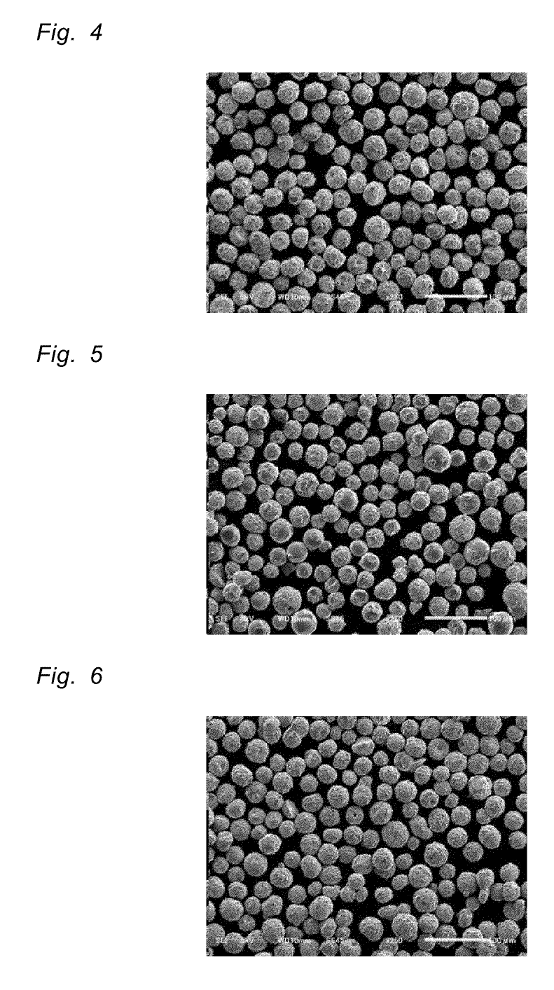

As raw materials, 7985 g of Fe₂O₃ (average particle diameter: 0.6 μm), 3145 g of Mn₃O₄ (average particle diameter: 0.9 μm) and 67 g of SrCO₃ (average particle diameter: 0.6 μm) were dispersed in 4800 g of pure water, as a dispersant, 67 g of the ammonium polycarboxylate-based dispersant was added, the slurry of a mixture obtained was used, the holding time at the calcination temperature of 1170° C. was set to 8 hours, the oxygen concentration within the electric furnace at the time of the temperature increase and holding was set to 1000 ppm and then a gas obtained by mixing oxygen and nitrogen was supplied into the furnace such that the oxygen concentration at the time of the cooling was 10000 ppm, with the result that calcination was performed. Furthermore, the obtained calcined material was disintegrated twice with the hammer mill (screen opening: 1.5 mm) and was then disintegrated once with the pulverizer. A carrier core material having an average particle diameter of 34.2 μm was obtained by the same method as in example 1 except that oxidation processing was thereafter performed for one hour under the atmosphere at a temperature of 360° C. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 4 shows a SEM photograph of the carrier core material in example 4.

### Example 5

As raw materials, 7985 g of Fe₂O₃ (average particle diameter: 0.6 μm), 261 g of MgO (average particle diameter: 0.8 μm), 2754 g of Mn₃O₄ (average particle diameter: 0.9 μm) and 24 g of SrCO₃ (average particle diameter: 0.6 μm) were dispersed in 4725 g of pure water, as a dispersant, 66 g of the ammonium polycarboxylate-based dispersant was added, the slurry of a mixture obtained was dried and the resulting granulated material was used, the holding time at the calcination temperature of 1300° C. was set to 6 hours, the oxygen concentration within the electric furnace at the time of the temperature increase and holding was set to 1000 ppm and then a gas obtained by mixing oxygen and nitrogen was supplied into the furnace such that the oxygen concentration at the time of the cooling was 10000 ppm, with the result that calcination was performed. Furthermore, a carrier core material having an average particle diameter of 34.8 μm was obtained by the same method as in example 1 except that the obtained calcined material was disintegrated twice with the hammer mill (screen opening: 0.3 mm) and was then disintegrated once with the pulverizer. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 5 shows a SEM photograph of the carrier core material in example 5.

### Comparative Example 1

As raw materials, 7985 g of Fe₂O₃ (average particle diameter: 0.6 μm), 3145 g of Mn₃O₄ (average particle diameter: 0.9 μm) and 67 g of SrCO₃ (average particle diameter: 0.6 μm) were dispersed in 4800 g of pure water, as a dispersant, 67 g of the ammonium polycarboxylate-based dispersant was added, the slurry of a mixture obtained was dried and the resulting granulated material was used, the holding time at the calcination temperature of 1300° C. was set to 6 hours, the oxygen concentration within the electric furnace at the time of the temperature increase and holding was set to 5000 ppm and then a gas obtained by mixing oxygen and nitrogen was supplied into the furnace such that the oxygen concentration at the time of the cooling was 5000 ppm, with the result that calcination was performed. Furthermore, the obtained calcined material was disintegrated twice with the hammer mill (screen opening: 1.5 mm) and was then not disintegrated with the pulverizer. A carrier core material having an average particle diameter of 34.1 m was obtained by the same method as in example 1 except that oxidation processing was thereafter performed for one hour under the atmosphere at a temperature of 500° C. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 6 shows a SEM photograph of the carrier core material in comparative example 1.

### Comparative Example 2

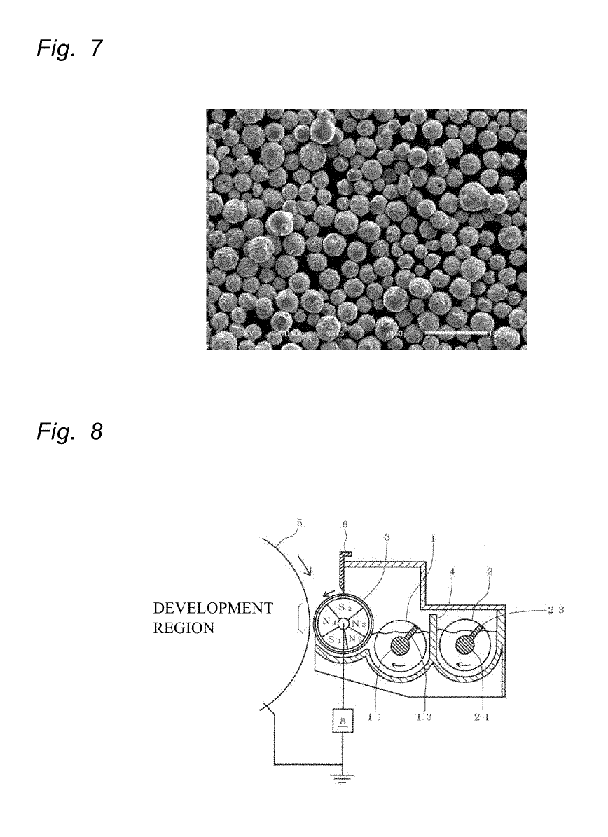

As raw materials, 7985 g of Fe₂O₃ (average particle diameter: 0.6 μm), 261 g of MgO (average particle diameter: 0.8 μm), 2754 g of Mn₃O₄ (average particle diameter: 0.9 μm) and 24 g of SrCO₃ (average particle diameter: 0.6 μm) were dispersed in 4725 g of pure water, as a dispersant, 66 g of the ammonium polycarboxylate-based dispersant was added, the slurry of a mixture obtained was dried and the resulting granulated material was used, the holding time at the calcination temperature of 1300° C. was set to 6 hours, the oxygen concentration within the electric furnace at the time of the temperature increase and holding was set to 5000 ppm and then a gas obtained by mixing oxygen and nitrogen was supplied into the furnace such that the oxygen concentration at the time of the cooling was 5000 ppm, with the result that calcination was performed. Furthermore, the obtained calcined material was disintegrated twice with the hammer mill (screen opening: 0.3 mm) and was then not disintegrated with the pulverizer. A carrier core material having an average particle diameter of 34.1 m was obtained by the same method as in example 1 except that oxidation processing was thereafter performed for one hour under the atmosphere at a temperature of 495° C. The composition of the obtained carrier core material, the difference between the lattice constants before and after the milling, the particle diameter (diameter) ratio in the bound particles, the proportion of the bound particles, the properties of development and the like were measured with methods described later. The results of the measurements are shown in tables 1 and 2. FIG. 7 shows a SEM photograph of the carrier core material in comparative example 2.

(Composition Analysis)

(Analysis of Fe)

The carrier core material containing an ion element was weighed and dissolved in mixed acid water of hydrochloric acid and nitric acid. This solution was evaporated to dryness and was thereafter dissolved again by adding sulfuric acid water thereto, and thus excessive hydrochloric acid and nitric acid were volatilized. Solid aluminum was added to this solution, and thus all Fe³⁺ ions in the liquid were reduced to Fe²⁺ ions. Then, the amount of Fe²⁺ irons in this solution was subjected to potentiometric titration using a potassium permanganate solution, and thus quantitative analysis was performed, with the result that the titer of Fe (Fe²⁺) was determined.

(Analysis of Mn)

For the content of Mn in the carrier core material, quantitative analysis was performed according to a ferromanganese analysis method (potentiometric titration method) described in JIS G 1311-1987. The content of Mn in the carrier core material described in the invention of the present application is the amount of Mn which was obtained by performing the quantitative analysis with the ferromanganese analysis method (potentiometric titration method).

(Analysis of Mg)

The content of Mg in the carrier core material was analyzed by the following method. The carrier core material according to the invention of the present application was dissolved in an acid solution, and quantitative analysis was performed by ICP. The content of Mg in the carrier core material described in the invention of the present application is the amount of Mg which was obtained by performing the quantitative analysis with ICP.

(Analysis of Sr)

The content of Sr in the carrier core material was determined by quantitative analysis with ICP as in the analysis of Mg.

(Difference Between Lattice Constants Before and after Milling of Carrier Core Material)

(Milling Conditions)

30 g of the produced carrier core material was put into a pot whose volume was 110 cm³ together with 250 g of Cr steel balls whose medium diameter was 6.5 mm and was milled with a small vibration mill (“HEIKO Sample Mill TI-100 model” made by HEIKO Co., Ltd.) for 5 hours.

(Measurement of Lattice Constants)

With an “Ultima IV” made by Rigaku Corporation, a powder X-ray diffraction measurement was performed on the carrier core material before and after the milling. As an X-ray source, a Cu bulb (Kα) was used, and x-rays were generated under conditions in which an acceleration voltage was 40 kV and a current was 20 mA. A divergence slit opening angle was set to 10, a scattering slit opening angle was set to 1°, a light reception slit width was 0.15 mm and a scan range was set to 15°≤2θ≤95°. Peak fitting was performed on the obtained X-ray diffraction pattern with a split pseudo Voigt function, and thus a diffraction angle was calculated accurately. A lattice constant was calculated with Bragg's equation from the calculated peak diffraction angle on the (311) plane of a spinel structure. Then, a difference between the lattice constants before and after the milling of the carrier core material was determined. The measurement before the milling was for the lattice constant on the surface of the carrier core material, and the measurement after the milling was for the lattice constant on the entire composition of the carrier core material

(Content Rate and Particle Diameter of Bound Particles)

The shape of the carrier core material was shot with the scanning electron microscope (JSM-6510LA made by JEOL Ltd.) at a magnification of 250. 400 particles were arbitrarily selected from the image shot, the number of bound particles among them was counted and the proportion of the number of bound particles contained in the 400 particles was set to the content rate of the bound particles.

The particle in which 2 to 5 spherical particles were bound together was regarded as the bound particle. Since the bound particle was present in a form in which a bound portion was shared by the spherical particles, the particle diameters of the spherical particles were individually calculated by approximating the particle to a spherical shape from a region obtained by removing the bound portion of the bound particles in the image that was obtained by shooting the shape of the carrier core material with the scanning electron microscope (JSM-6510LA made by JEOL Ltd.) at a magnification of 250.

(Apparent Density)

The apparent density of the carrier core material was measured according to JIS Z 2504.

(Fluidity)

The fluidity of the carrier core material was measured according to JIS Z 2502.

(Average Particle Diameter)

The average particle diameter of the carrier core material was measured with a laser diffraction type particle size distribution measuring device (“Microtrac Model 9320-X100” made by Nikkiso Co., Ltd.).

(Magnetic Properties)

A room-temperature dedicated vibration sample type magnetometer (VSM) (“VSM-P7” made by Toei Industry Co., Ltd.) was used to apply an external magnetic field in a range of 0 to 79.58×10⁴ A/m (10000 oersteds) continuously in one cycle, and thus saturated magnetization, residual magnetization, a coercive force and magnetization σ₁ₖ (Am²/kg) in a magnetic field of 79.58×10³ A/m (1000 oersteds) were measured.

(Electrical Resistance)

Two brass plates whose surfaces were electropolished and whose thicknesses were 2 mm were arranged as electrodes such that the distance between the electrodes was 2 mm, 200 mg of the carrier core material was inserted into a gap between the two electrode plates, then a magnet having a cross-sectional area of 240 mm² was arranged behind each of the electrode plates, in a state where a bridge of powder to be measured was formed between the electrodes, direct-current voltages of 100 V, 250 V, 500 V and 1000 V were applied between the electrodes and thus values of currents flowing through the carrier core material were measured by a four-terminal method. The electrical resistance of the carrier core material was calculated from the current values and the electrode-to-electrode distance of 2 mm and the cross-sectional area of 240 mm².

(Production of Developer)

A carrier was produced by coating the surface of the obtained carrier core material with a resin. Specifically, 450 weight parts of silicone resin and 9 weight parts of (2-aminoethyl) aminopropyl trimethoxysilane were dissolved in 450 weight parts of toluene serving as a solvent, and thus a coat solution was produced. The coat solution was applied with a fluidized bed-type coating device to 50000 weight parts of the carrier core material and was heated with an electric furnace whose temperature was 300° C., and thus the carrier was obtained. Likewise, in all examples and comparative examples which will be described below, the carrier was obtained.

The obtained carrier and a toner whose average particle diameter was about 5.0 μm were mixed with a pot mill for a predetermined time, and thus a two-component electrophotographic developer was obtained. In this case, the carrier and the toner were adjusted such that weight of the toner/(weight of the toner and the carrier)=5/100. Likewise, in all examples and comparative examples which will be described below, the developer was obtained. The obtained developer was put into the development device of a structure shown in FIG. 8 (the peripheral speed of a development sleeve Vs: 406 mm/sec, the peripheral speed of a photosensitive drum Vp: 205 mm/sec and a photosensitive drum-to-development sleeve distance: 0.3 mm),

(Evaluation of Image Memory)

Images in which a solid image portion and a non-image portion were adjacent in the longitudinal direction of the photosensitive drum and in which subsequently, a halftone of a wide area was continuous were acquired after the initial image formation and the image formation of 200 thousand sheets, in the second revolution of a development roller, the image densities of a region where a solid image was developed and a region where a solid image was not developed in the first revolution of the development roller were measured with a reflection densitometer (Model Number TC-6D made by Tokyo Denshoku Co., Ltd.) and thus the difference thereof was determined and evaluation was performed with the following criteria. The results are also shown in table 2.

“©”: less than 0.003

“O”: equal to or more than 0.003 but less than 0.006

“Δ”: equal to or more than 0.006 but less than 0.020

“x”: equal to or more than 0.020

(Evaluation of Carrier Scattering)

1000 white sheets of A4-size were printed, then the number of black spots on the 1000th sheet was visually measured and evaluation was performed with the following criteria. The results are also shown in table 2.

“©”: no black spots

“O”: 1 to 5 black spots

“Δ”: 6 to 10 black spots

“x”: 11 or more black spots

TABLE 1

| | | | | | Powder properties | | | | | | |
|---|---|---|---|---|---|---|---|---|---|---|---|
| | | | | | | | Average | | | | |
| | | | | | Apparent | | particle | Magnetic properties | | | |
| | Composition (mol %) | | | | density | Fluidity | diameter | σs | σ 1000 | σr | Hc |
| | Fe₂O₃ | MgO | MnO | SrO | (g/cm³) | (sec) | (μm) | Am²/kg | Am²/kg | Am²/kg | A/m × 10³/(4π) |
| Example 1 | 50 | 0 | 50 | 0.8 | 2.27 | 34.7 | 33.7 | 70.0 | 59.5 | 1.0 | 11.6 |
| Example 2 | 50 | 0 | 50 | 0.7 | 2.25 | 38.4 | 35.1 | 70.2 | 59.7 | 1.1 | 12.9 |
| Example 3 | 50 | 0 | 50 | 0.7 | 2.21 | 39.4 | 35.0 | 70.2 | 59.7 | 1.0 | 11.0 |
| Example 4 | 55 | 0 | 45 | 0.5 | 2.25 | 31.4 | 34.2 | 71.0 | 59.8 | 1.0 | 11.4 |
| Example 5 | 54 | 7 | 39 | 0.2 | 2.23 | 35.6 | 34.8 | 68.2 | 58.5 | 0.8 | 9.1 |
| Comparative | 55 | 0 | 45 | 0.5 | 2.25 | 33.8 | 34.1 | 68.9 | 59.0 | 0.9 | 10.7 |
| example 1 | | | | | | | | | | | |
| Comparative | 54 | 7 | 39 | 0.2 | 2.26 | 30.4 | 34.1 | 70.6 | 59.6 | 0.9 | 10.9 |
| example 2 | | | | | | | | | | | |

TABLE 2

| | | | | Bound | Bound | Lattice constant | | | | |
|---|---|---|---|---|---|---|---|---|---|---|
| | | | | particle | particle | Before | After | Lattice constant | | |
| | Resistance value (Ω · cm) | | | proportion | diameter | milling | milling | difference | Development | Carrier |
| | 100 V | 250 V | 1000 V | (%) | ratio | Å | Å | Å | memory | scattering |
| Example 1 | 1.4E+0.9 | 6.1E+0.8 | 5.4E+0.7 | 5 | 0.7 | 8.497 | 8.498 | 0.001 | ◯ | © |
| Example 2 | 1.4E+0.9 | 6.3E+0.8 | 7.5E+0.7 | 10 | 0.8 | 8.496 | 8.497 | 0.001 | © | © |
| Example 3 | 1.3E+0.9 | 6.2E+0.8 | 7.8E+0.7 | 20 | 0.8 | 8.495 | 8.499 | 0.004 | ◯ | ◯ |
| Example 4 | 2.0E+0.9 | 6.2E+0.8 | 1.5E+0.8 | 6 | 0.7 | 8.498 | 8.499 | 0.001 | © | © |
| Example 5 | 8.6E+0.8 | 4.8E+0.8 | 5.9E+0.7 | 5 | 0.7 | 8.455 | 8.460 | 0.005 | ◯ | ◯ |
| Comparative | 2.6E+0.8 | 2.3E+0.8 | 1.3E+0.8 | 6 | 0.8 | 8.508 | 8.515 | 0.007 | ◯ | Δ |
| example 1 | | | | | | | | | | |
| Comparative | 4.5E+0.8 | 2.9E+0.8 | 1.9E+0.8 | 8 | 0.7 | 8.480 | 8.489 | 0.009 | ◯ | X |
| example 2 | | | | | | | | | | |

As is clear from tables 1 and 2, in the developers using the carrier core materials of examples 1 to 5 satisfying the content of the bound particles and the difference between the lattice constants specified in the present invention, the occurrence of development memory and carrier scattering was reduced. In the developers satisfying the difference between the lattice constants, the difference between the surface and the whole of the carrier core material is low, and thus even for the bound particles and chips produced by the cracking or chipping of the other normal spherical particles, it was possible to reduce the lowering of the insulation, that is, lowering beyond the original electrical resistance of the carrier core material was reduced, the adherence to the surface of the photosensitive member was reduced and thus it was possible to reduce the generation of black spots or white spots.

On the other hand, in the developers using the carrier core materials of comparative examples 1 and 2 in which the difference between the lattice constants was more than 0.005, carrier scattering was seen.

### INDUSTRIAL APPLICABILITY

According to the carrier core material of the present invention, it is possible to increase the amount of toner supplied to a development region, and thus it is possible to reduce the occurrence of development memory. Moreover, it is useful that even when cracking or chipping occurs in the carrier core material, the adherence of carriers to the surface of a photosensitive member is reduced and thus an image failure such as black spots or white spots is reduced.

### REFERENCE SIGNS LIST

3 development roller
5 photosensitive drum

1. A carrier core material that is represented by a composition formula MₓFe₃₋ₓO₄ (where M is Mn and/or Mg, and X is a total of Mn and Mg and is a substitution number of Fe by Mn and Mg, 0<X≤1),
wherein 5 to 20 number percent of bound particles in which 2 to 5 spherical particles are bound together are contained, and
an absolute value of a difference between lattice constants before and after milling which are calculated from a peak position of plane indices (311) in a powder X-ray diffraction pattern is equal to or less than 0.005.

2. The carrier core material according to claim 1,
wherein a volume average particle diameter is equal to or more than 25 μm but less than 50 μm.

3. An electrophotographic development carrier,
wherein a surface of the carrier core material according to claim 1 is coated with a resin.

4. An electrophotographic developer comprising:
the electrophotographic development carrier according to claim 3; and
a toner.
